(19) United States
(12) Patent Application Publication
(10) Pub. No.: US 2008/0142305 A1
(43) Pub. Date: Jun. 19, 2008

(54) WIRE LUBRICATING DEVICE AND METHOD

(76) Inventors: Kenneth Mesker, Kitty Hawk, NC (US); Thomas James Hagadone, Kitty Hawk, NC (US)

Correspondence Address: PASSE' INTELLECTUAL PROPERTY, LLC, 1717 BRASSFIELD RD., RALEIGH, NC, 27614, US

(21) Appl. No.: 11/612,297

(22) Filed: Dec. 18, 2006

(51) Int. Cl. F16N 7/00

(52) U.S. Cl. 184/15.1

(57) ABSTRACT

The present invention relates generally for a device used to apply a polymeric lubricant to the outer surface of insulated electrical wire or the like while pulling the wire through a conduit and for methods of lubricating an insulated electrical wire as it is pulled through a conduit. It consists of a rigid cylindrical body, an internal reservoir for holding polymeric wire lubricant, a connection means to a conduit and a means for inserting wire into the device.

### BACKGROUND OF THE INVENTION

1. Field of the Invention

The present invention relates generally for a device used to apply a polymeric lubricant to the outer surface of insulated electrical wire or the like while pulling the wire through a conduit and for methods of lubricating an insulated electrical wire as it is pulled through a conduit.

2. Description of Related Art

During the constriction of dwellings and commercial buildings having electrical service the electrical wires are normally protected from the surrounding environment by metal conduit. Normally this conduit is made of aluminum or other lightweight material and while the walls are exposed bolted to the surrounding wall studs braces and flooring joists. Following the installation of conduit electrical wire is pulled through the conduit to the desired position. The friction between the outer insulation of electrical wiring and the inside surface of conduit is normally very high and absent sufficient lubrication of either the interior surface of the conduit or the exterior of the wire, the wire can easily get stuck during the pulling process.

It is common to use liquid soap as a lubricant with the electrician placing the soap in their hands and wipe it on the wire as a second electrician pulls the wire into place. More recently polymeric lubricants have been used which are more efficient, and easier to use but the problems of mess and needing to apply by hand while another pulls the wire are still an issue. A number of devices over the years have been developed for lubricating wires.

U.S. Pat. No. 3,565,213 to Heller discloses a fitting that is screwed into an opening in each coupling or pipe section and lubricant is injected into the conduit through a fitting. In U.S. Pat. No. 4,475,629 to Jonnes a method and apparatus for metering and applying lubricant to the inner surface of conduit is described. In both U.S. Pat. Nos. 5,632,356 and 6,725,973 describe methods for applying lubricant directly to the wire or cable both include pipe fittings to inject lubricant as well as several means for building the device. Neither of the devices is self contained and both only deal with getting lubricant into a reservoir and not designing to maximize the amount of lubricant applied to the wire or cable.

There still exists a need for a device that is simple to use self contained inexpensive to build yet still accomplishes what other more complicated devices have done.

### SUMMARY OF THE INVENTION

The present invention provides a wire lubricating device and method of its use which applies polymeric wire lubricant to electrical wire as it pulled through conduit. The device does not require attachment to pressure devices, is simple to use without the lubricant touching the electricians hands and provide for a smoother pulling of wire and less chance of damaging wire without the need for someone to hold the wire as it is feed into the conduit and lubricate it.

Accordingly in one aspect of the invention it relates to a device for lubricating a wire as it enters a wire conduit comprising:
a) a cylindrical body having an interior reservoir for containing a polymeric wire lubricant said reservoir being tapered from a distal end to a proximal end;
b) a connection means for providing flow communication between the reservoir proximal end and a conduit;
c) an opening in the cylindrical body at the distal end in flow communication with the reservoir such that a wire entering the opening can pass from the opening through the reservoir and out the connection means.

The invention also relates to a method of lubricating a wire for movement through a conduit comprising:
d) selecting a device for lubricating a wire as it enters a wire conduit comprising, a cylindrical body having an interior reservoir containing a polymeric wire lubricant said reservoir being tapered from a distal end to a proximal end; a connection means for providing flow communication between the reservoir proximal end and a conduit; an opening in the cylindrical body at the distal end in flow communication with the reservoir such that a wire entering the opening can pass from the opening through the reservoir and out the connection means;
e) connecting the cylindrical body to a conduit;
f) inserting a wire into the opening through the reservoir end of the cylindrical body and out the connection means into the conduit; and
g) pulling the wire into the conduit to a desired location.

These and other features and advantages of the present invention will become apparent to those skilled in the art upon a reading of the specification when viewed especially in conjunction with the drawings of the embodiments of the invention depicted.

### BRIEF DESCRIPTION OF THE DRAWINGS

FIG. 1 is a perspective view of the device of the invention

FIG. 2 is a perspective cut-away view of the invention attached to a conduit with a wire positioned for pulling through the conduit.

FIG. 3 is a view of the reservoir from inside the device separated from the cylinder.

### DETAILED DESCRIPTION OF THE INVENTION

The present invention relates to a device and a method of using the device for lubricating electrical wire or the like with a polymeric wire lubricant when pulling the wire through a conduit. It consists of a cylinder with a reservoir which is tapered from the distal end (farthest away from the conduit where the wire is introduced) to the distal end (closest to the conduit.

The present invention also describes methods for lubricating an electrical wire comprising inserting a wire into a cylindrical device having a tapered reservoir containing a polymeric wire lubricant such that it exits the reservoir and enters a conduit for pulling.

Unless otherwise indicated, the following terms are intended to have the following meanings in interpreting the present invention.

As used herein “lubricating a wire” refers to applying a polymeric wire lubricant such as used in the electrical trade for lubricating wire during wire pulling inside a conduit. Commercially currently available products such as Clear Glide and 3M's WL wire pull lubricant are examples of polymeric wire lubricant available to those in the art.

As used herein “a cylindrical body having an interior reservoir” refers to a body capably of containing a quantity of polymeric wire lubricant. The size depends on what the user can ultimately handle based on weight and the ability to handle the device but in general the cylinder would in one embodiment have a diameter of about 2 inches to about 12 inches, while in another embodiment the cylinder would have a diameter of about 2 inches to about 6 inches. The cylinder should be made of a ridged but lightweight material for example a rigid polymer such a polyvinylchloride however other polymers are certainly suitable and within the skill in the art of choosing. Metals such as aluminum could be used as well but the ability to be able to handle the material as well as issues involving cost and the like will enter into the decision in the selection of materials. One skilled in the art likewise with the disclosure herein would be able to select a rigid material suitable for a cylinder. The “tapered reservoir” as used herein is an internal reservoir for holding a quantity of the polymeric wire pulling lubricant. It is tapered from the largest end being distal from the attachment to the conduit and narrowest proximal or closes to the wire conduit to be attached. In other words the basic shape of the reservoir would be conical in nature. Although, a mathematical cone might have smooth sides in another embodiment of the invention the walls of the reservoir are ruffled, fluted or wavy creating a larger surface area to the wall of the reservoir. The exact angle of the reservoir “cone’ can vary. In one embodiment the angle is between about 5 degrees and about 30 degrees. The larger the distal end of the cone the larger amount of the lubricant can be contained in the reservoir. The basics of the reservoir are to taper the reservoir to a smaller opening to insure the rapid and even coating of the wire as it leaves the proximal end of the device and enters a conduit. The reservoir can be made of a rigid or a softer material. Where the reservoir is made of a soft flexible polymeric material or fabric the reservoir could be considered a bladder type reservoir. In one embodiment the material is elastomeric and shrinks as the amount of lubricant in the reservoir decreases. In one embodiment materials for the reservoir are polymeric and fabric cloth. In another embodiment the reservoir is a rigid polymeric material. One skilled in the art can determine other materials suitable as well as compatible with the exact wire lubricant chosen.

As used herein a “connection means for providing flow communication between the reservoir proximal end and a conduit” means, as used herein, a means for connecting the device of the invention directly to a conduit opening such that the wire may travel from the device and into the conduit for pulling. The proximal end as used herein refers to the end of the cylinder designed to attach to a conduit opening. The connection may be done such that it is a tight fit such as by a threaded conduit connector or may be a device that is press fit onto a conduit tight enough to remain but loose enough to remove easily when the wire pulling is completed. The connection means is placed such that a wire passing through the reservoir may exit the device from the connection means and enter a conduit lubricated. One skilled in the art after inspecting the figures will be able to design appropriate connections means suitable for individual uses of the device.

As used herein “an opening in the cylindrical body at the distal end” is meant and opening that allows a wire to be lubricated to be inserted in to the opening such that it passes from the opening into the reservoir and the lubricant therein, and picks up a sufficient amount of lubricant passing through the reservoir such that it is lubricated once it leaves the device out of the communication means at the proximal end of the device ready to enter a conduit for pulling.

In one embodiment the device can have a means for preventing the lubricant from falling out of the device. This can be in the form of an end cap, cover or the like which can be removed during use of the device in order to pass the wire though the device of the invention.

In using the device of the invention the user takes the desired piece of wire an initially feeds it into the distal opening. The wire then feeds into the reservoir which is in communication with the opening and which has been filled to a desired amount with a polymeric wire lubricant. The wire is fed all the way through the reservoir and out the distal end. The distal end of the device has been attached or connected to a conduit and as the wire leaves the device it enters the conduit. Once the wire is in the conduit the user can pull the wire to the desired location. As the wire passes through the device it is coated by the lubricant in the reservoir. The cylinder is refilled by adding lubricant to either end opening since there is no other openings in the cylinder. This arrangement of the invention avoids hook-ups to lubricant cylinders or tanks and makes it lightweight and easy to use.

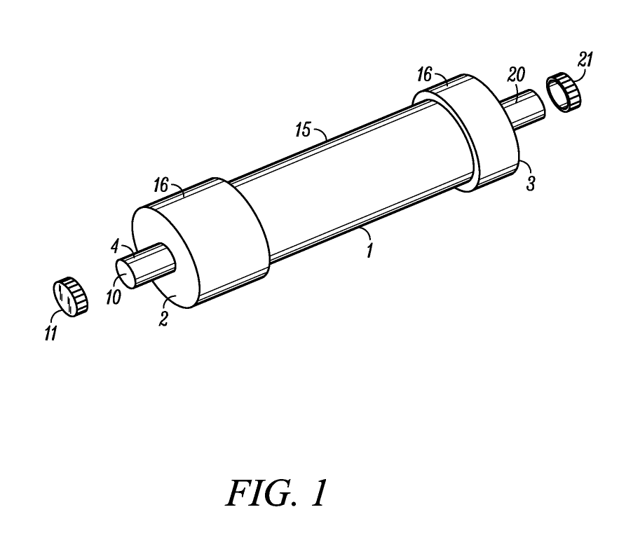

Now referring to the drawings FIG. 1 is an embodiment of the invention in perspective view. Cable lubricating device 1 is shown not in use. Cable lubricating device 1 has proximal end 2 and distal end 3. Mounted on proximal end 2 is a conduit connection means 4. Conduit connection means 4 in this embodiment is designed to slide onto a conduit and the Conduit connection means 4 has an opening inner diameter 10 just larger than the outer diameter of the conduit it is designed to be used with. The conduit connector 4 can be permanent attached to cable lubricating device 1 or can be designed to be removable so that a different connector can be attached when a different sized conduit is being used. The conduit connection means could, for example be screwed into the cable lubrication device 1 so that removal and replacement is relatively easy.

Also shown in this embodiment is optional conduit connection means cover 11 which can be positioned over the opening inner diameter 10 preventing any wire lubricant inside the cable lubricating device 1 from spilling out the opening 10. The cylindrical potion of the device consists of the cylindrical body 15 which is in this embodiment a straight piece of 4 inch polyvinyl pipe terminated at each end by pipe ends 16 which taper the cylindrical body 15 down to a size suitable for mounting the conduit connection means 4.

At proximal end 3 there is wire entrance 20 where the user of the cable lubrication device 1 initially puts the wire to be lubricated. The actual opening can vary based on the size of the wire to be inserted and like the conduit connection means 4 can be permanently or temporarily mounted to accommodate different size wires. Additional wire lubricant can be added through this opening in-between uses. In order to prevent lubricant from escaping an optional wire opening end cap 21 is shown. Wire opening end cap 21 can be placed on the opening during travel and storage of the device but is not necessary for the functioning of the device.

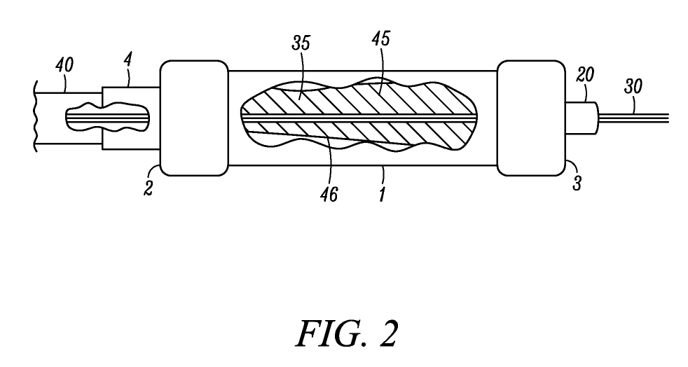

FIG. 2 is a perspective view of the invention showing a cut-away of the device 1 with a wire 30 running through the lubricant containing reservoir 35. The wire 30 has entered the device 1 via the distal opening 20 and it passes into the interior of the device 1 and into reservoir 35 where it comes in contact with wire lubricant 45. the wire which has now picked up a lubricant coating, exits the device 1 via the proximal connection means and enters a conduit 40 for pulling to the desired location. This perspective also sows in the interior of device 1 the tapered walls 46 of the reservoir. In this embodiment the taper is very noticeable but in other embodiments the taper need not be so great. This particular embodiment shoes that the proximal connector 4 is pushed onto the conduit 40 such that it is held on by friction of the two pieces.

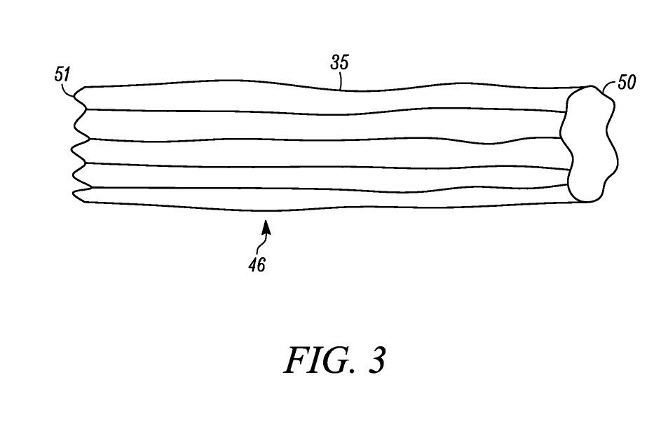

FIG. 3 is a perspective of the reservoir 35 separated from the cylindrical portion of the device. In this embodiment the walls are show to be ruffled or fluted. The reservoir distal end 50 is positioned toward the distal wire opening 20 and the reservoir proximal end 51 is positioned toward the conduit connection means 4 within the cylindrical portion of the device.

Operation of the wire lubricating device 1 is accomplished as follows with the aforementioned embodiment of the device in FIGS. 1 through 3. The reservoir 35 is filled with a wire lubricant 45. Next a wire 30 is inserted into the distal wire entrance 20 and all the way into the reservoir 35 where it picks up lubricant 45. The wire 30 continues to the conduit 40 where it can be pulled by conventional means to a desired location.

It can be seen from the preceding description that the methods and device of the invention eliminates the need for bulky tanks while minimizing mess and waste as well as eliminate the need for the wire to be hand fed through the lubricant. It should be noted that the particular embodiments described herein in detail are examples only. Variation on materials shape and the like are within the scope of the invention as taught herein. Accordingly the details described herein are illustrative only and not to be interpreted as limiting the features herein.

What is claimed is:

1. A device for lubricating a wire as it enters a wire conduit consisting essentially of:
a) a cylindrical body having an interior reservoir for containing a polymeric wire lubricant said reservoir being tapered from a distal end to a proximal end;
b) a connection means for providing flow communication between the reservoir proximal end and a conduit;
c) an opening in the cylindrical body at the distal end in flow communication with the reservoir such that a wire entering the opening can pass from the opening through the reservoir and out the connection means.

2. A device according to claim 1 wherein the connection means is a threaded cylindrical connector positioned along a longitudinal axis of the cylindrical body for connection to a conduit.

3. A device according to claim 1 wherein the taper measured at the proximal end is between about 5 degrees and about 30 degrees.

4. A device according to claim 1 wherein the shape of the taper is conical.

5. A device according to claim 1 wherein the shape of the taper is a fluted conical shape.

6. A device according to claim 1 which further comprises a polymeric wire lubricant positioned in the reservoir.

7. A device according to claim 1 which further comprises a means for preventing the lubricant from falling out of the device reservoir.

8. A method of lubricating a wire for movement through a conduit comprising:
a) selecting a device for lubricating a wire as it enters a wire conduit comprising, a cylindrical body having an interior reservoir containing a polymeric wire lubricant said reservoir being tapered from a distal end to a proximal end; a connection means for providing flow communication between the reservoir proximal end and a conduit; an opening in the cylindrical body at the distal end in flow communication with the reservoir such that a wire entering the opening can pass from the opening through the reservoir and out the connection means;
b) connecting the cylindrical body to a conduit;
c) inserting a wire into the opening through the reservoir end of the cylindrical body and out the connection means into the conduit; and
d) pulling the wire into the conduit to a desired location.
